(19) United States
(12) Patent Application Publication
(10) Pub. No.: US 2009/0103724 A1
(43) Pub. Date: Apr. 23, 2009

(54) COMMUNICATION DEVICE AND REKEYING CONTROL METHOD IN SECURED COMMUNICATION

(76) Inventor: MASAYOSHI TAMAI, Tokyo (JP)

Correspondence Address: NEC CORPORATION OF AMERICA, 6535 N. STATE HWY 161, IRVING, TX, 75039, US

(21) Appl. No.: 12/252,990

(22) Filed: Oct. 16, 2008

(30) Foreign Application Priority Data
Oct. 17, 2007 (JP) 2007-269602

(51) Int. Cl. H04L 9/06

(52) U.S. Cl. 380/44

(57) ABSTRACT

A communication device which performs automatic rekeying in a secured communication system, includes: a rekeying time manager for generating a rekeying request at a previously designated rekeying time; and a rekeying controller for controlling the automatic rekeying to forcefully perform rekeying based on the rekeying request.

This application is based upon and claims the benefit of priority from Japanese Patent Application No. 2007-269602, filed on Oct. 17, 2007, the disclosure of which is incorporated herein in its entirety by reference.

### BACKGROUND OF THE INVENTION

1. Field of the Invention

The present invention relates to a communication system using a security function such as IPsec (Internet Protocol Security) protocols and, more particularly, to an automatic rekeying control method and a communication device using the same.

2. Description of the Related Art

In IPsec communication, automatic key generation is performed using IKE (Internet Key Exchange) protocol, and a security association (SA) is established between communicating devices (see RFC2409, RFC4306, and others). To enhance security, rekeying needs to be performed when a certain length of time has passed.

Rekeying is performed when a preset lifetime has passed, or when the amount of SA data communication (traffic) has exceeded a predetermined amount, since a SA was established. However, since rekeying increases the load on the communicating devices and network, it is preferable that rekeying be performed during a time of day when the load is as light as possible.

For example, a case will be considered where, with a SA lifetime of 24 hours, a company makes setting such that SA creation is performed during the night (here, at 1:00 a.m.), when traffic is relatively light. In this case, rekeying is performed at one o'clock at night everyday, as shown in FIG. 1A, as long as the system operates normally.

However, if the network goes down due to a reboot of any one of the communicating devices itself, peripheral equipment down or the like, the IPsec communication is cut off and the SA is deleted. Thereafter, when recovery from the failure or the like has been made and IPsec communication has become possible again, rekeying is and will be performed at the time when the recovery was made, at every 24-hour interval, as shown in FIG. 1B. That is, rekeying is performed during a time of day (here, at 10:00 a.m.) that is different from the night time originally set.

If rekeying is performed at an unpredicted time as described above, management and control of the load of rekeying on the network become difficult. To resolve this deviation of the rekeying time, every time deviation occurs, a new SA needs to be set by manual operations or external operations through a network management device. In the external operations, it is necessary for an operator to determine the load state of the virtual private network (VPN) communication equipment and the state of the network and to decide whether or not to perform rekeying.

In a case where the number of IPsec sessions is large in particular, when a SA is established for each IPsec session, a collision or congestion of rekeying processing may occur during a certain time of day. If an attempt is made to avoid such a collision or congestion through external operations, more time is taken to perform rekeying.

Japanese Patent Application Unexamined Publication No. 2002-374238 discloses an automatic key management system that solves the above problems by allowing communicating devices to indefinitely set the expiry date of keys. However, to maintain the strength of security in IPsec communication, the keys to be used needs to be changed periodically.

### SUMMARY OF THE INVENTION

An object of the present invention is to provide a communication device and a rekeying control method that can solve the above-described problems and can manage and control the load of rekeying processing on a network.

According to the present invention, a communication device performing automatic rekeying in a secured communication system, includes: a rekeying time manager for generating a rekeying request at a previously designated rekeying time; and a rekeying-instruction controller for controlling the automatic rekeying to forcefully perform rekeying based on the rekeying request.

A rekeying control method in a communication device which performs automatic rekeying in a secured communication system, includes: generating a rekeying request at a previously designated rekeying time; and controlling the automatic rekeying to forcefully perform rekeying based on the rekeying request.

According to the present invention, it is possible to manage and control the load of rekeying processing on a network.

### BRIEF DESCRIPTION OF THE DRAWINGS

FIG. 1A is a time chart showing an example of the operations of a general VPN device when no system failure occurs.

FIG. 1B is a time chart showing an example of the operations of the general VPN device when a system failure occurs.

FIG. 2 is a block diagram showing a functional configuration of a VPN device that is a communication device according to an exemplary embodiment of the present invention.

FIG. 3 is a flow chart showing the overall operations of the VPN device shown in FIG. 2.

FIG. 4 is a flow chart showing an example of load distribution control in the VPN device shown in FIG. 2.

FIG. 5A is a time chart showing an example of the operations of the VPN device according to the present exemplary embodiment when no system failure occurs.

FIG. 5B is a time chart showing an example of the operations of the VPN device according to the present exemplary embodiment when a system failure occurs.

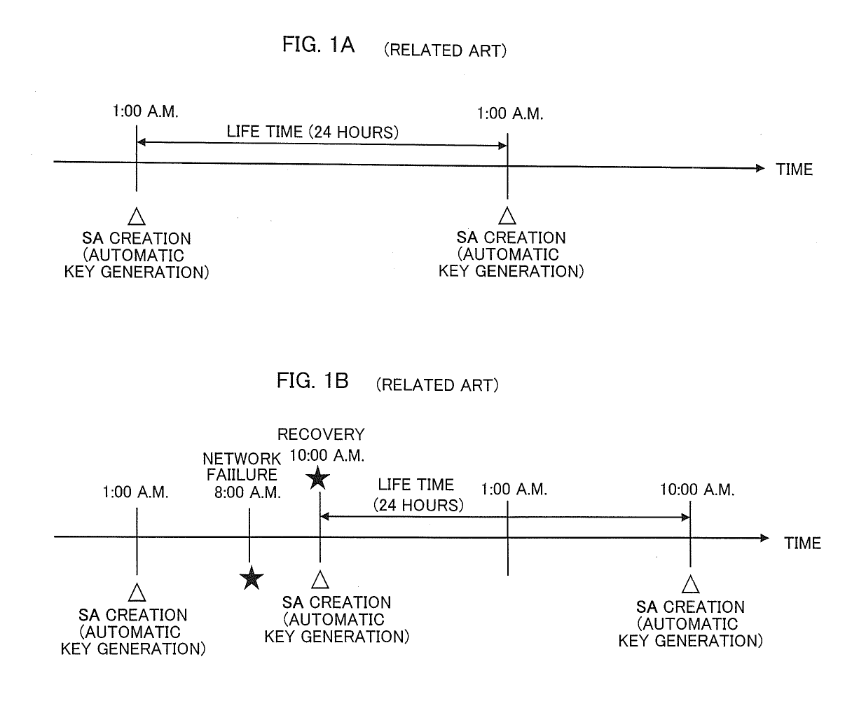

### DETAILED DESCRIPTION OF THE PREFERRED EMBODIMENTS

### 1. Device Configuration

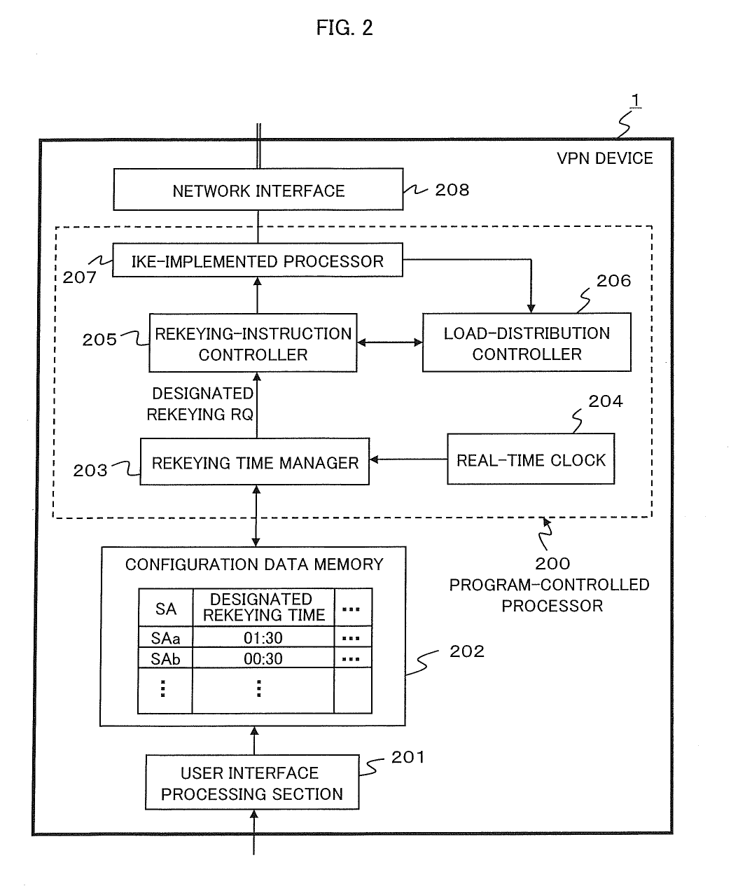

FIG. 2 is a block diagram showing a functional configuration of a virtual private network (VPN) device that is a communication device according to an exemplary embodiment of the present invention. The VPN device 1 includes a user interface processing section 201 and a configuration data memory 202. Security association (SA) information such as rekeying conditions and SA lifetimes, which is input from the user interface processing section 201, is stored in the configuration data memory 202. For the rekeying conditions, a rekeying time, date, day of the week, and/or the like can be designated.

A rekeying time manager 203 checks the rekeying conditions for the individual SAs stored in the configuration data memory 202, while referring to a date and time supplied from a real-time clock 204. When it is the rekeying time designated for a certain SA and this SA's condition is met, the rekeying time manager 203 notifies a rekeying-instruction controller 205 that it is time to perform rekeying for the SA in question. For example, if a SAa's rekeying condition stored in the configuration data memory 202 is designated as “daily 1:30 a.m.,” the rekeying time manager 203 notifies the rekeying-instruction controller 205 at 1:30 a.m. every day that it is time to perform rekeying for the SAa.

The rekeying-instruction controller 205 notifies a load-distribution controller 206 that it is time to perform rekeying, which has been notified from the rekeying time manager 203. The load-distribution controller 206 determines timing, and at that timing, the rekeying-instruction controller 205 outputs an instruction to perform rekeying (rekeying instruction) to an IKE-implemented processor 207. Monitoring such timings at which rekeying is performed, the load-distribution controller 206 distributes the timings at which individual rekeying should be performed, so that a collision or congestion of the plurality of rekeying processings is avoided. The details thereof will be described later.

The IKE-implemented processor 207 is composed of a processor which implements ISAKMP (Internet Security Association and Key Management Protocol), IKE (Internet Key Exchange) protocol, and a policy data base (DB), which are defined by RFC 2409, RFC 4306, and others. Incidentally, an IPsec automatic rekeying program is executed by the IKE-implemented processor 207, and rekeying is performed with a communication device on the other end of the communication through a network interface 208.

Note that similar rekeying and load distribution functions can be implemented by executing programs for rekeying control and load distribution control, which will be described below, on a program-controlled processor 200 such as a CPU.

### 2. Rekeying Control

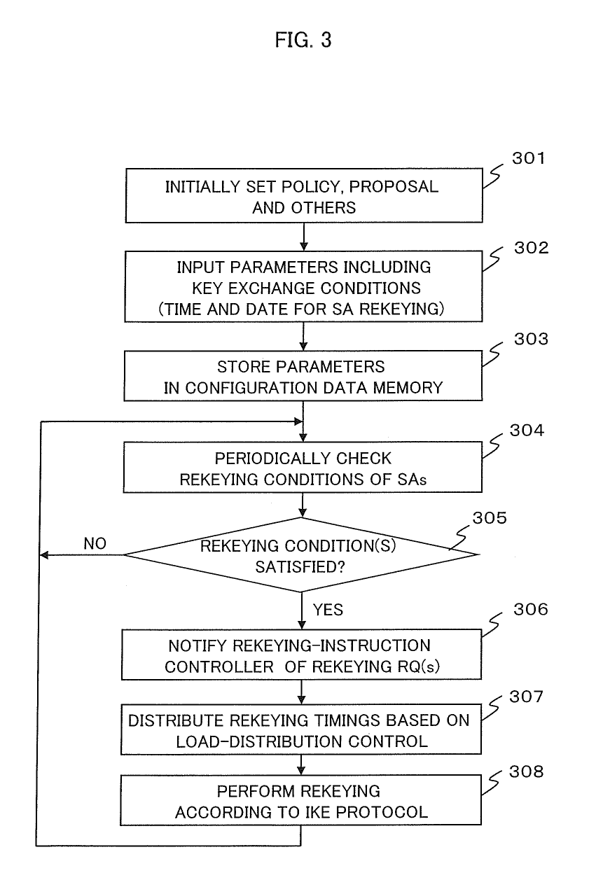

FIG. 3 is a flow chart showing the overall operations of the VPN device shown in FIG. 2. First, as initial setting, a policy and proposal for IPsec are set through the user interface processing section 201 (Step 301). The lifetime of each SA, which is set as a rekeying condition here, is set at a large value in the proposal kept through an existing IKE configuration (or an existing duration of the IKE lifetime value) so that management control is possible.

Next, a date, a day of the week, an hour and/or minutes when rekeying is performed, as well as a SA for which rekeying is performed, and a rekeying condition or conditions, are input as designated parameters through the user interface processing section 201 (Step 302). In this event, with consideration given to the performance of the VPN device 1, the maximum number of rekeying processings that can be concurrently performed is determined. However, various time parameters such as the date, day-of-the-week, hour and minutes parameters make flexible setting possible, such as daily, weekly, hourly or minutely rekeying.

Each parameter set through the user interface processing section 201 is kept and managed in the configuration data memory 202 (Step 303). The rekeying time manager 203 periodically checks the real-time clock 204 at predetermined periods (Step 304) and determines whether or not any SA exists that meets its rekeying condition (here, the designated time (hour and minutes)) among the parameters stored in the configuration data memory 202 (Step 305). If a SA exists that meets its rekeying condition (Step 305: YES), the rekeying time manager 203 notifies a request for rekeying (rekeying request) for this SA to the rekeying-instruction controller 205 (Step 306). If there is no SA that meets its rekeying condition (Step 305: NO), the control process goes back to Step 304.

The rekeying-instruction controller 205 notifies the rekeying request on this SA to the load-distribution controller 206. The load-distribution controller 206 periodically measures the load on the VPN device 1 and distributes timings to carry out requested rekeying (rekeying timings) so that the load on the VPN device 1 is evened out and that a collision with another rekeying or congestion of rekeying processing is avoided (Step 307).

In accordance with a rekeying timing notified from the load-distribution controller 206, the rekeying-instruction controller 205 instructs the IKE-implemented processor 207 to carry out rekeying for the SA in question, whereby automatic rekeying processing is started and rekeying is performed in accordance with IKE protocol (Step 308). That is, the rekeying-instruction controller 205 forces the IKE-implemented processor 207 to perform automatic rekeying processing at the specific time. When the rekeying has been performed in this manner, the control process goes back to Step 304.

### 3. Load Distribution Control

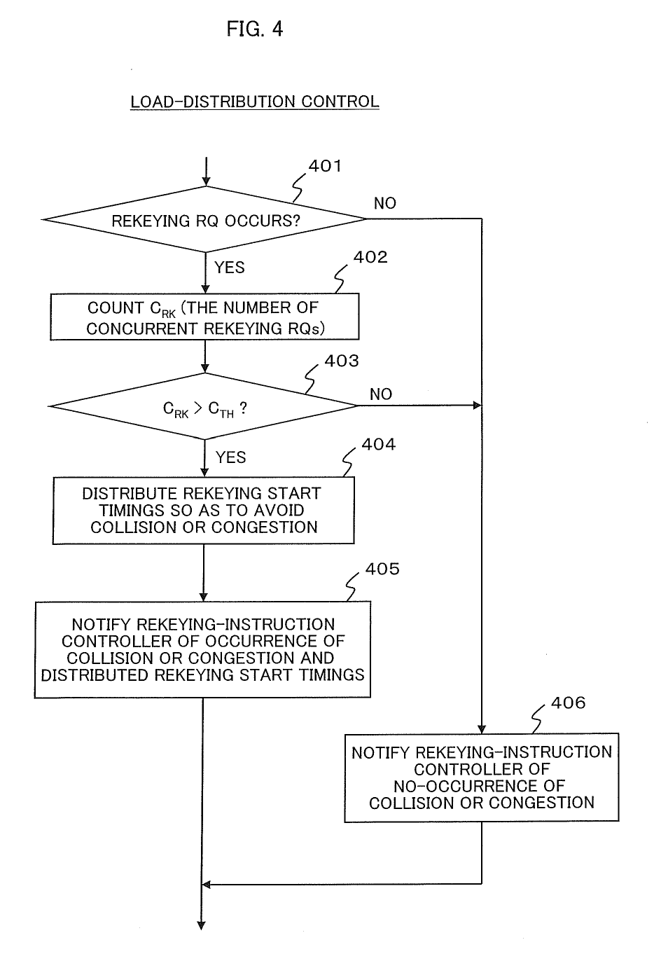

FIG. 4 is a flow chart showing an example of the load distribution control performed in the VPN device shown in FIG. 2. Here, it is assumed that automatic rekeying requests are made from a plurality of IPsec sessions at the same time. Great amounts of resources are consumed when a plurality of rekeying requests occur at the same time and respective rekeying processings corresponding to the requests run in parallel, as described earlier. To avoid this, here, the maximum number of parallel processings is predetermined. When the number of automatic rekeying requests exceeds the maximum number of parallel processings (which will cause occurrence of a collision or congestion), load control is performed by discarding or holding the rekeying requests.

Referring to FIG. 4, when an automatic rekeying request occurs (Step 401: YES), the load-distribution controller 206 counts the number of rekeying requests (Step 402) and compares a count value CRK of the number of rekeying requests with the maximum number CTH of parallel processings kept in advance (Step 403). When the count value CRK exceeds the maximum number CTH (Step 403: YES), the load-distribution controller 206 detects that a collision or congestion of automatic rekeying processings will occur.

When detecting such a possible occurrence of a collision or congestion, the load-distribution controller 206 distributes the load on the VPN device 1 by shifting timings to start automatic rekeying (rekeying start timings) so that the collision or congestion is avoided (Step 404). The load-distribution controller 206 notifies the rekeying-instruction controller 205 of the possible occurrence of a collision or congestion as well as the distributed rekeying start timings (Step 405).

When there is no automatic rekeying request occurring (Step 401: NO), or when the count value CRK is not larger than the maximum number CTH (Step 403: NO), the load-distribution controller 206 notifies the rekeying-instruction controller 205 that no collision or congestion is occurring (Step 406).

As another example of the load distribution control, it is possible to adopt an algorithm in which every time each communication device detects a collision or congestion of automatic rekeying processings, the times at which automatic rekeying processing is performed are distributed by using random numbers.

Moreover, as a relatively simple example of the load distribution control, it is also possible to use an algorithm in which, with a random number table or the like incorporated in a program in advance, the times at which automatic rekeying processing is performed are distributed in accordance with the random number table upon possible occurrence of a collision or congestion of automatic rekeying processings.

Further, as yet another example of the load distribution control, there is also an algorithm in which a communicating device notifies that it is busy and makes a request to temporarily suspend (hold) the processing by sending a pause packet or the like to a communicating device on the other end of communication.

### 4. Specific Examples

Next, as an example, description will be given of a case of a company that has a large amount of communication during the day and desires to perform communication with security enhanced by IPsec. Since this company desires to impose as little load as possible on a network during the day when traffic is heavy, it is desirable that rekeying for IPsec be performed during the night every day. Here, description will be given of the operations of the VPN device according to the above-described exemplary embodiment in a case where setting is made such that rekeying is performed at one o'clock at night (1:00 a.m.) every day. According to the exemplary embodiment, it is possible that rekeying is performed at a designated time without being influenced by system down or the like.

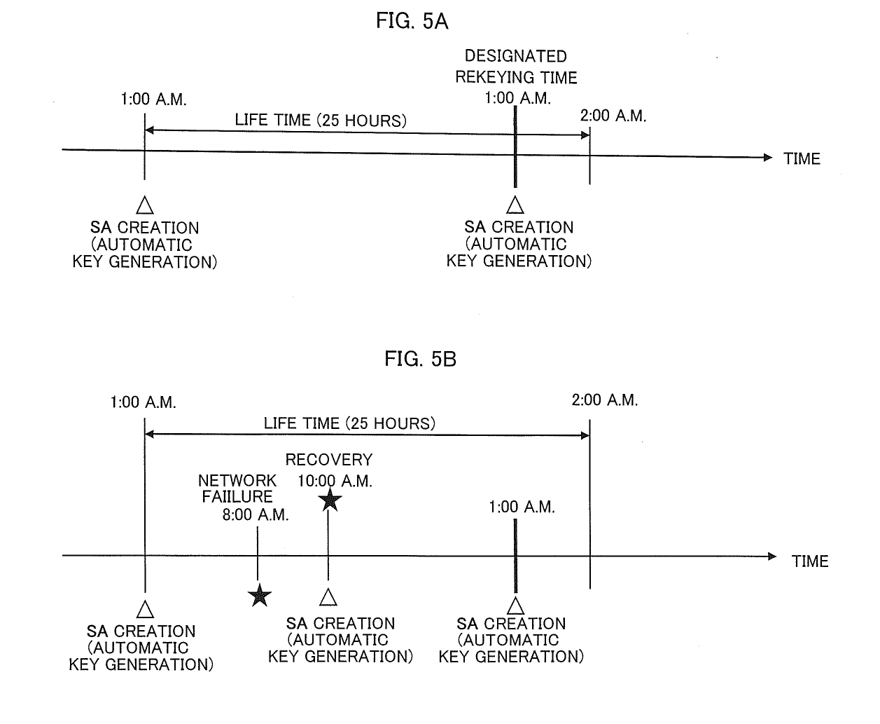

FIG. 5A is a time chart showing an example of the operations of the VPN device according to the exemplary embodiment in a case where no system failure occurs. FIG. 5B is a time chart showing an example of the operations of the VPN device according to the exemplary embodiment in a case where a system failure occurs.

Referring to FIG. 5A, in a case where no system failure occurs, rekeying is carried out at one o'clock at night (1:00 a.m.) every day as is set.

Referring to FIG. 5B, it is assumed that a network failure occurred at 8:00 a.m. and system recovery was complete at 10:00 a.m. As an example of the network failure, the IPsec communication is cut off and the SA is deleted due to an event such as a reboot of the VPN device itself, a reboot of the other-end VPN device, a disconnection of a repeater network device or the network. In this case, although the IPsec communication is cut off and the SA is deleted at 8:00 a.m., when recovery is made thereafter, an SA having a predetermined lifetime (25 hours) is created. However, according to the present exemplary embodiment, regardless of the lifetime, rekeying can be performed at 1:00 a.m. every day as is originally set. That is, even if a valid key exists at the preset time, automatic key generation is forcefully carried out. As described above, the VPN device in the present example can perform rekeying at the fixed time every day, without being influenced by the network, VPN device itself or peripheral equipment.

Incidentally, in the present example shown in FIGS. 5A and 5B, the lifetime of a SA is set to be 25 hours, which is longer then the rekeying period between the fixed time (here, 24 hours). The reason is as follows. If the lifetime is set to be 24 hours, there is a possibility that automatic key generation processing cannot be started at the preset time, since there are sometimes when the rekeying start timing is randomly delayed by the above-described load-distribution controller 206 when it is detected that a collision or congestion of automatic rekeying processing will occur. Therefore, with consideration given to the load distribution control, the lifetime is set to be 25 hours, which is sufficiently long, whereby even when automatic key generation processing cannot be started at the preset time due to a collision or congestion of automatic key generation processing, automatic key generation can be performed within the period when the previously generated keys are still valid.

Moreover, in the present example, the load distribution control is performed upon detection of a collision or congestion, whereby, even if a plurality of rekeying processings are performed at the same designated time, the load on the VPN device is evened out, so that it is possible to prevent imposing load on the VPN device and network. Accordingly, in the present example, management and control of rekeying can be performed by the VPN device alone such that rekeying is managed without manual operations and performed at a planned time, that the load of rekeying on the network is distributed, and that little load is imposed on the network.

### 5. Effects

As described hereinabove, the effects of the present exemplary embodiment of the present invention are as follows.
(1) The load on a network can be managed and controlled by automatically performing rekeying at a designated date, time and/or the like when the load on the network is light.
(2) It is possible to prevent a deterioration of the strength of security caused by long-term use of the same key.
(3) Rekeying can be carried out at the designated time even if a SA deletion occurs due to an unplanned cutoff of IPsec.
(4) Since the rekeying start timing can be controlled by time designation, the flexibility of the rekeying control is improved.
(5) Even if a collision or congestion of rekeying processing frequently occurs during the same time of day, rekeying can be performed by distributing and evening out the load on the VPN device while monitoring the load.

Incidentally, in the present exemplary embodiment, rekeying is carried out by activating IKE for an existing SA. However, even in a case, for example, where no SA exists because of some factor, recovery from a cutoff of IPsec communication can be accomplished by making it possible to flexibly cope with the operations in such a case by using parameters.

For example, when no SA exists, the following processing is possible: creating a new SA if a policy has been registered; performing rekeying only for an ISAKMP SA; performing rekeying only for an IPsec SA while leaving an ISAKMP SA as it is; and the like. Moreover, for the detection of the rekeying load on the VPN device and a collision or congestion of rekeying processing, it is also possible to use any of known collision detection algorithms, external collision detection algorithms and the like.

Examples of the above-mentioned known collision detection algorithms and external collision detection algorithms include algorithms in which a collision or congestion is determined based on the CPU activity ratio, and algorithms in which a collision or congestion is detected based on the use state of a security chip and the like, as well as algorithms in which a collision or congestion is detected from a memory resource as described above. The algorithms in which a collision or congestion is determined based on the CPU activity ratio include, for example, an algorithm in which when the CPU activity ratio is 80% or more, an occurrence of a collision or congestion is recognized, and no new IKE request is accepted. Examples of the security chip include a large-scale integrated circuit (LSI) performing arithmetic calculation such as cryptographic calculation. The use state of a security chip is, for example, a state in which a semaphore for exclusive control cannot be secured, or the like.

Hence, according to the present exemplary embodiment of the present invention, it is possible to perform periodic rekeying independently of the lifetime of an SA and the traffic, and it is also possible to perform rekeying operation in a state where rekeying can be managed and controlled. Thus, rekeying can be managed at a time when risk incurred by performing automatic rekeying is limited, without reducing the strength of security. Moreover, according to the present exemplary embodiment of the present invention, with the provision of a function of detecting a collision or congestion of rekeying processing performed during the same time of day, the load on the VPN device can be evened out, whereby the collision or congestion of rekeying processing can be prevented.

As described above, according to the present invention, in a VPN device performing IPsec, automatic rekeying for IPsec can be performed at a designated time, without a user carrying out external operations. Thus, it is possible to perform management and control such that automatic rekeying is carried out at a time when the load on the VPN device is light, and that the load states of the VPN device and network are recognized at a designated time and the load is evened out.

In other words, on the VPN device, a control program is executed for performing rekeying at a time designated on the bases of date, day of the week and/or time. Thus, automatic rekeying can be carried out, without requiring external operations, at a time when it is planned that the load on the network and VPN equipment is light, whereby it is possible to manage and control rekeying, without reducing the strength of security. In addition, it is also possible to perform control such that the load on the VPN equipment and network is evened out by detecting a collision or congestion of automatic rekeying processing.

The present invention may be embodied in other specific forms without departing from the spirit or essential characteristics thereof. The above-described exemplary embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

1. A communication device which performs automatic rekeying in a secured communication system, comprising:
a rekeying time manager for generating a rekeying request at a previously designated rekeying time; and
a rekeying controller for controlling the automatic rekeying to forcefully perform rekeying based on the rekeying request.

2. The communication device according to claim 1, wherein the rekeying controller distributes rekeying start timing depending on a load state of the automatic rekeying.

3. The communication device according to claim 2, wherein the rekeying controller evens out the load state of the automatic rekeying depending on detection of collision and/or congestion of the rekeying request.

4. The communication device according to claim 2, wherein when a number of rekeying requests exceeding a predetermined value occur at same rekeying time, the rekeying controller determines that collision and/or congestion of the rekeying requests occurs.

5. The communication device according to claim 1, wherein the rekeying controller starts the automatic rekeying when the communication system recovers at a time other than the previously designated rekeying time, wherein at the previously designated rekeying time after the automatic rekeying has completely recovered, the rekeying controller forcefully performs the rekeying.

6. The communication device according to claim 1, wherein the automatic rekeying is performed according to IKE (Internet Key Exchange) in IPsec (Internet Protocol Security).

7. A communication system comprising a plurality of communication devices each performing automatic rekeying, wherein each of the communication devices comprises:
a rekeying time manager for generating a rekeying request at a previously designated rekeying time; and
a rekeying controller for controlling the automatic rekeying to forcefully perform rekeying based on the rekeying request.

8. The communication system according to claim 7, wherein the rekeying controller distributes rekeying start timing depending on a load state of the automatic rekeying.

9. The communication system according to claim 8, wherein the rekeying controller evens out the load state of the automatic rekeying depending on detection of collision and/or congestion of the rekeying request.

10. The communication system according to claim 8, wherein when a number of rekeying requests exceeding a predetermined value occur at same rekeying time, the rekeying controller determines that collision and/or congestion of the rekeying requests occurs.

11. The communication system according to claim 7, wherein the rekeying controller starts the automatic rekeying when the communication system recovers at a time other than the previously designated rekeying time, wherein at the previously designated rekeying time after the automatic rekeying has completely recovered, the rekeying controller forcefully performs the rekeying.

12. The communication system according to claim 7, wherein the automatic rekeying is performed according to IKE (Internet Key Exchange) in IPsec (Internet Protocol Security).

13. A rekeying control method in a communication device which performs automatic rekeying in a secured communication system, comprising:
generating a rekeying request at a previously designated rekeying time; and
controlling the automatic rekeying to forcefully perform rekeying based on the rekeying request.

14. The rekeying control method according to claim 13, wherein rekeying start timing is distributed depending on a load state of the automatic rekeying.

15. The rekeying control method according to claim 14, wherein the load state of the automatic rekeying is evened out depending on collision and/or congestion of the rekeying request.

16. The rekeying control method according to claim 14, wherein when a number of rekeying requests exceeding a predetermined value occur at same rekeying time, it is determined that collision and/or congestion of the rekeying requests occurs.

17. The rekeying control method according to claim 13, wherein the automatic rekeying is started when the communication system recovers at a time other than the previously designated rekeying time, wherein at the previously designated rekeying time after the automatic rekeying has completely recovered, the rekeying is forcefully performed.

18. The rekeying control method according to claim 13, wherein the automatic rekeying is performed according to IKE (Internet Key Exchange) in IPsec (Internet Protocol Security).

19. A computer-readable program for instructing a computer to perform automatic rekeying in a communication device of a secured communication system, the program comprising:
a function of generating a rekeying request at a previously designated rekeying time; and
a function of controlling the automatic rekeying to forcefully perform rekeying based on the rekeying request.
